(19) United States
(12) Patent Application Publication
(10) Pub. No.: US 2025/0210023 A1
(43) Pub. Date: Jun. 26, 2025

(54) HELMHOLTZ RESONATOR, ACOUSTIC METAMATERIAL, ACOUSTIC ABSORBER, SOUND OUTPUT DEVICE AND MICROPHONE

(71) Applicant: Sony Group Corporation, Tokyo (JP)

(72) Inventors: Falk-Martin HOFFMANN, Baden-Württemberg (DE); Takehiko TANAKA, Tokyo (JP)

(73) Assignee: Sony Group Corporation, Tokyo (JP)

(21) Appl. No.: 18/845,446

(22) PCT Filed: Mar. 22, 2023
(86) PCT No.: PCT/EP2023/057383

§ 371 Date: Sep. 10, 2024

(30) Foreign Application Priority Data
Mar. 28, 2022 (EP) 22164643.3

(51) Int. Cl. G10K 11/172; G10K 11/162; H04R 1/28

(52) U.S. Cl. CPC G10K 11/172; G10K 11/162; H04R 1/2869; G10K 2210/32272

(57) ABSTRACT

A Helmholtz resonator is provided. The Helmholtz resonator includes a body enclosing a cavity. The cavity serves as acoustic compliance of the Helmholtz resonator. Further, the Helmholtz resonator includes an acoustic horn extending from an opening in the body into the cavity. The acoustic horn serves as acoustic mass of the Helmholtz resonator.

### FIELD

The present disclosure relates to a Helmholtz resonator and further to an acoustic metamaterial, an acoustic absorber, a sound output device and a microphone.

### BACKGROUND

Helmholtz resonators have many applications in acoustics and have further gained in relevance as an essential component in acoustic metamaterials.

A conventional Helmholtz resonator consists of an acoustic mass (e.g., a form of channel with rigid walls) coupled to a rigidly enclosed volume of background medium/fluid, acting as an acoustic compliance. The dimensions of both components determine the resonance frequency and the Q-factor (indicative of the “sharpness” of the resonance peak, and thus related to the losses) of the Helmholtz resonator.

Generally, it may be said that Helmholtz resonators are preferably kept as small as possible (particularly when used in acoustic metamaterials), to keep both weight and physical volume to a minimum. This becomes particularly challenging when the resonance frequency is very low, i.e., when the dimensions of the Helmholtz resonator are much smaller than the wavelength (e.g., factor 20 or more).

Furthermore, the application in acoustic metamaterials usually requires the Helmholtz resonator's interface to be embedded into a rigid surface, leading to a housing for the Helmholtz resonator that is cubical. That way, it may easily couple to a channel or be arranged to form a larger surface loaded with Helmholtz resonators. The resulting acoustic metamaterials quickly become very heavy (due to a significant percentage of solid material) or very difficult to manufacture (e.g., when the mass channel is elaborately wound up).

To reach particularly low resonance frequencies and gain control on the obtained quality factor (and thus the loss factor in the Helmholtz resonator), while not increasing the occupied space, the mass channel may be embedded into the compliance volume. However, also this measure limits the Helmholtz resonator's performance, particularly when a high degree of acoustic absorption is the target and the losses in the resonator are too small (e.g., for acoustic metamaterial absorbers).

Hence, there may be a demand for an improved Helmholtz resonator.

### SUMMARY

This demand is met by a Helmholtz resonator, an acoustic metamaterial, an acoustic absorber, a sound output device and a microphone in accordance with the independent claims. Advantageous embodiments are addressed by the dependent claims.

According to a first aspect, the present disclosure provides a Helmholtz resonator. The Helmholtz resonator comprises a body enclosing a cavity. The cavity serves as acoustic compliance of the Helmholtz resonator. Further, the Helmholtz resonator comprises an acoustic horn extending from an opening in the body into the cavity. The acoustic horn serves as acoustic mass of the Helmholtz resonator.

According to a second aspect, the present disclosure provides an acoustic metamaterial comprising one or more Helmholtz resonator as proposed herein.

According to a third aspect, the present disclosure provides an acoustic absorber comprising one or more Helmholtz resonator as proposed herein.

According to a fourth aspect, the present disclosure provides a sound output device. The sound output device comprises one or more electroacoustic transducer configured to convert a respective electrical audio signal into sound. Further, the sound output device comprises one or more Helmholtz resonator as proposed herein configured to control propagation of the sound.

According to a fifth aspect, the present disclosure provides a microphone. The microphone comprises one or more electroacoustic transducer configured to convert sound into a respective electrical audio signal. Further, the microphone comprises one or more Helmholtz resonator as proposed herein configured to control propagation of the sound within the microphone.

### BRIEF DESCRIPTION OF THE FIGURES

Some examples of apparatuses and/or methods will be described in the following by way of example only, and with reference to the accompanying figures, in which

FIG. 1 illustrates an example of a Helmholtz resonator;

FIG. 2 illustrates an exemplary comparison of the acoustic impedances of a Helmholtz resonator comprising an acoustic horn and another Helmholtz resonator comprising a tubular duct, either serving as acoustic mass;

FIG. 3 illustrates an example of an acoustic metamaterial;

FIG. 4 illustrates an example of an acoustic absorber;

FIG. 5 illustrates an example of a sound output device; and

FIG. 6 illustrates an example of a microphone.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

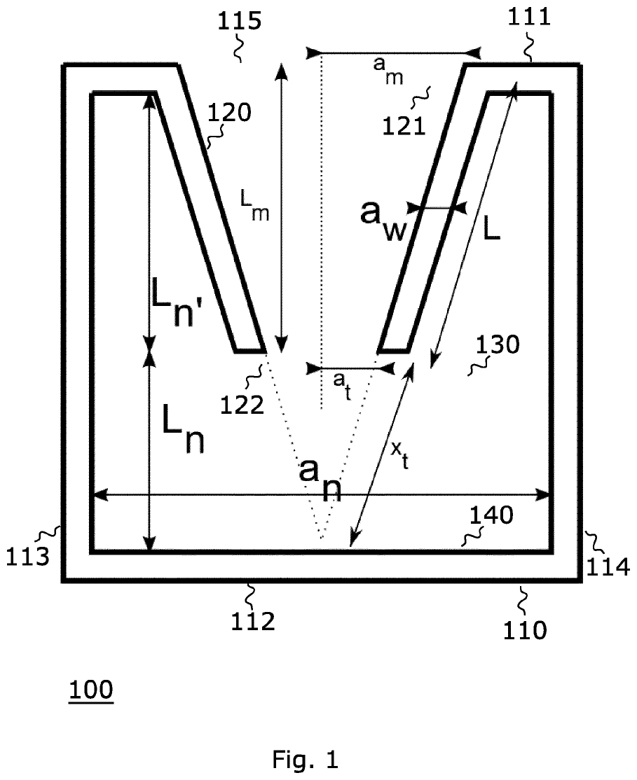

FIG. 1 illustrates a cross-sectional view of a Helmholtz resonator 100. The Helmholtz resonator 100 comprises a body 110 enclosing a cavity 130. The body is formed of rigid material. The cavity 130 serves (acts) as acoustic compliance of the Helmholtz resonator 100. A propagation medium for sound such as a fluid (e.g., a gas and/or a liquid) is present in the cavity and the surrounding of the Helmholtz resonator 100. Further, the Helmholtz resonator 100 comprises an acoustic horn 120. The acoustic horn 120 extends from an opening 115 in the body 110 into the cavity 130. The acoustic horn 120 serves (acts) as acoustic mass of the Helmholtz resonator 100.

The acoustic horn 120 extends exclusively inside the cavity 140. In other words, the acoustic horn 120 does not extend outside the body 110. As can be seen from FIG. 1, a cross section of the acoustic horn 120 decreases with increasing distance from the opening 115 in the body 110.

The acoustic horn 120 enables impedance matching and acts like the acoustical equivalent of an electrical transformer. Additionally, the acoustic horn 120 holds a reactive impedance component in the form of an acoustical mass. As such, it forms a Helmholtz resonator in combination with the attached acoustic compliance, but it also serves as a transformer to better match the impedance of the Helmholtz resonator 100 to the impedance of the equivalent acoustic transmission line in front of it (i.e., in front of the opening 115). The equivalent acoustic transmission line is an acoustic channel whose cross sectional area is equal to the area encompassed by the outer dimensions of the body 110's wall in which the opening 115 is formed (i.e., the side wall 111 in the example of FIG. 1). The transformer's transmission ratio helps to transform the connected impedance (including its resistive component) to effectively create a different value on its interface, while letting it interact with its own inherent mass and resistive component. This adds another degree of control to the Helmholtz resonator 100. The connected impedance is the compliance of the Helmholtz resonator 100.

Accordingly, the Helmholtz resonator 100 may allow (more) ideal absorption at its resonance frequency.

In the example of FIG. 1, the acoustic horn 120 exhibits a conic shape. However, it is to be noted that the present disclosure is not limited thereto. In general, the acoustic horn 120 may exhibit any shape providing acoustic properties suitable for the desired application. For example, the acoustic horn may alternatively exhibit a hyperbolic shape, a parabolic shape or an exponential shape.

In the example of FIG. 1, the body 110 exhibits a cube shape. However, it is to be noted that the present disclosure is not limited thereto. In general, the body 110 may exhibit any shape suitable for the desired application. For example, the body 110 may exhibit a rectangular parallelepiped shape, parallelepiped shape, a cylindrical shape, etc. The cube shape and the rectangular parallelepiped shape may be advantageous in case several Helmholtz resonators 100 are to be arranged next to each other.

As can be seen from FIG. 1, the mouth 121 of the acoustic horn 120 extends from the opening 115 in the body 110. The throat 122 of the acoustic horn 120 is arranged in the cavity 130 and spaced apart from the opening 115 in the body 110. The cross section of the acoustic horn 120 decreases from the mouth 121 to the throat 122 of the acoustic horn.

In the example of FIG. 1, the body 110 and the acoustic horn 120 are formed integrally. For example, the Helmholtz resonator 100 may be formed by means of an additive manufacturing process. However, it is to be noted that the present disclosure is not limited thereto. In other examples, the body 110 and the acoustic horn 120 may be provided as separate elements that are attached to each other (e.g., by means of welding, soldering, gluing, screwing, etc.). Similarly, the body 110 may be formed from separate elements that are attached to each other. In the example of FIG. 1, the four side walls 111, 112, 113 and 114 of the body 110 are formed integrally. However, as stated above, they may alternatively be formed as separate wall parts and be attached to each other (e.g., by means of welding, soldering, gluing, screwing, etc.). Further, it is to be noted that the position of the opening 115 is not limited to the upper wall 111 as illustrated in FIG. 1. In general, the opening 115 may be provided in any side wall of the of the body 110. For example, the opening 115 may be provided in one of the side walls 112, 113 and 114 in alternative examples. Accordingly, the acoustic horn may extend from the respective one of the side walls 112, 113 and 114 into the cavity 130.

The horn shape of the acoustic horn 120 gives high stability to the Helmholtz resonator 100's acoustic mass. In particular, as the mouth 121 is wider than the throat 122 of the acoustic horn 120, the acoustic horn 120 is more stable than the tubular shape used for the acoustic mass in conventional Helmholtz resonators. Accordingly, the acoustic horn 120 is coupled to the body 110 only by means of the mouth 121 of the acoustic horn 120. In other words, no additional support of the acoustic horn 120 on the body 110 is needed. In particular, no additional horizontal support structure for supporting the acoustic horn 120 against the side walls 113 and 114 of the body against vibrations is needed-unlike many conventional Helmholtz resonators using a tubular shape for the acoustic mass.

As is evident from the above explanations, the proposed Helmholtz resonator 100 comprises only passive acoustic elements (components). In other words, the proposed Helmholtz resonator 100 does not comprise any active acoustic elements (components). A passive acoustic element is an acoustic element not requiring an external source of energy in order to perform its function. As the name ‘passive’ suggests-passive acoustic elements do not provide gain or amplification to sound. Passive acoustic elements cannot amplify or generate sound. On the other hand, an active acoustic element is an acoustic element requiring an external source of energy in order to perform its function. Active acoustic elements can generate and/or amplify sound.

All internal dimensions of the Helmholtz resonator 100 such as the vertical distance Lₙ of the throat 122 of the acoustic horn 120 to the inner surface of the side wall 111, the wall thickness α_{w} of the acoustic horn 120, the vertical distance Lₙ of the throat 121 of the acoustic horn 120 to the inner surface of the side wall 112, which is opposite to the side wall 111 of the body 110 in which the opening 115 is formed, or the lengths of the side walls such as the length αₙ of the side wall 112 are much smaller than a wavelength of sound with which the Helmholtz resonator 100 is to interact.

It is evident for a person skilled in the art that exact dimensions of the individual elements (components) of the Helmholtz resonator 100 depend on the desired acoustic properties of the Helmholtz resonator 100. For example, the dimensions of the individual elements (components) of the Helmholtz resonator 100 depend on the target (desired) resonance frequency and the target (desired) impedance of the Helmholtz resonator 100.

For example, the following relation between the pressure and volume velocity at the throat 122 and the mouth 121 of the conically shaped acoustic horn 120 applies:

$$( \begin{matrix}{p}_{m} \\ {q}_{m}\end{matrix} ) = ( \begin{matrix}A & B \\ C & D\end{matrix} ) ( \begin{matrix}{p}_{t} \\ {q}_{t}\end{matrix} ) \qquad ( 1 )$$

The elements of the system matrix are given as follows:

$$A = \frac{{a}_{t}}{{a}_{m}} [ cos kL + \frac{1}{k {x}_{t}} sin kL ] \qquad ( 2 )$$

$$B = - i {R}_{0} \frac{{a}_{t}}{{a}_{m}} sin kL \qquad ( 3 )$$

$$C = \frac{- i}{{R}_{0}} [ ( \frac{{x}_{m}}{{x}_{t}} + {( \frac{1}{k {x}_{t}} )}^{2} ) sin kL - \frac{L}{{kx}_{t}^{2}} cos kL ] \qquad ( 3 )$$

$$D = \frac{{a}_{m}}{{a}_{t}} [ cos kL - \frac{1}{k {x}_{m}} sin kL ] \qquad ( 4 )$$

with

$${x}_{m} = {x}_{t} + L , {R}_{0} = \frac{{ρ}_{0} {c}_{0}}{π {a}_{t}^{2} F} ,$$

F=2(1−cos θ₀)/sin²θ₀, and

$$sin {θ}_{0} = \frac{{a}_{t}}{{x}_{t}} . \qquad {c}_{0}$$

denotes the phase velocity (e.g., the speed of sound) and ρ₀ denotes the mass density of the propagation medium. The various quantities are geometrically defined in FIG. 1. In particular, αₘ denotes the radius of the mouth 122 of the acoustic horn 120, αₜ denotes the radius of the throat 121 of the acoustic horn 120, L denotes the length of the acoustic horn, Lₘ denotes the vertical distance of the throat 122 of the acoustic horn 120 to the opening 115 in the body 110 (i.e., the outer surface of the side wall 111), and xₜ denotes the distance of the throat 122 of the acoustic horn 120 to an intersection of the inner surface of the opposing side wall 112 and an imaginary extension of the acoustic horn 120 towards the side wall 112. Furthermore, k denotes the acoustic wavenumber and is defined as

$$k = \frac{ω}{{c}_{0}}$$

with ω=2πf of being the angular frequency. k may be replaced by γ=k+i·β to account for losses. β is a coefficient describing the acoustic loss with distance.

Assuming that the throat 122 of the acoustic horn is loaded with the acoustic impedance Zₙ of the Helmholtz resonator 100's acoustic compliance, the pressure pₜ and the volume velocity qₜ at the throat 121, respectively, would be related through this load impedance. Therefore, the acoustic impedance Z_{HR} of the Helmholtz resonator 100, which is the combined acoustic impedance of the acoustic compliance and the acoustic mass (i.e., the acoustic horn 120), when looking into the horn 120 at the mouth 121, may be defined as:

$${Z}_{H R} = \frac{A {Z}_{n} + B}{{CZ}_{n} + D} \qquad ( 5 )$$

The equivalent “turns ratio” Φ of this acoustic transformer is given by the ratio of the mouth and throat radius:

$$Φ = \frac{{a}_{m}}{{a}_{t}} \qquad ( 6 )$$

The resonance frequency of the Helmholtz resonator 100 may be approximated for the lossless case. The acoustic impedance Zₙ of the acoustic compliance may be approximated as follows:

$${Z}_{n} = \frac{i}{ω {n}_{c}} , \qquad ( 7 )$$

where

$${n}_{c} = \frac{{V}_{c}}{{ρ}_{0} {c}_{0}^{2}} .$$

The term V_{c} denotes the volume of the acoustic compliance, which may be calculated as follows:

$$\begin{matrix}{V}_{C} = {a}_{n}^{2} ( {L}_{n} + {L}_{n}^{′} ) \\ - \frac{1}{3} π ( {L}_{m} - {a}_{w} ) [ {( {a}_{m} + {a}_{w} )}^{2} + ( {a}_{t} + {a}_{w} ) ( {a}_{m} + {a}_{w} ) + {( {a}_{t} + {a}_{w} )}^{2} ]\end{matrix} \qquad ( 8 )$$

From the above, the acoustic impedance of the acoustic compliance may be approximated. The vertical distance Lₘ of the throat 122 of the acoustic horn 120 to the opening 115 in the body 110 relates to the horn parameter L as follows:

$${θ}_{0} = arc tan \frac{{a}_{m} - {a}_{t}}{{L}_{m}} \qquad ( 9 )$$

$$and$$

$$L = \frac{{a}_{m} - {a}_{t}}{sin {θ}_{0}} \qquad ( 10 )$$

The Helmholtz resonator 100's acoustic impedance is given by the above mathematical expression (5). At resonance frequency, the acoustic impedance's imaginary part must be equal to zero. In the case of no losses, this leads to the following criterion:

$$cos kL + \frac{sin kL}{k {x}_{t}} = ω {n}_{c} {R}_{0} sin kL \qquad ( 11 )$$

Mathematical expression (11) can be approximately solved when Lₘ is much smaller than the wavelength of the sound with which the Helmholtz resonator 100 is to interact. The resonance frequency of the Helmholtz resonator 100 may be approximated as follows:

$${f}_{0} \approx \frac{1}{2 π} \sqrt{\frac{{c}_{0} ( 1 + \frac{L}{{x}_{t}} )}{{n}_{c} {R}_{0} L}} \qquad ( 12 )$$

Given a target frequency and target dimensions of the body 110 as boundary parameters, the dimensions of the various components of the Helmholtz resonator 100 may, e.g., be determined iteratively based on the above mathematical expressions using a parameter optimization method (algorithm). For example, a genetic algorithm may be used to determine the dimensions of the various components of the Helmholtz resonator 100.

In order to avoid very high losses (e.g., an acoustic impedance at resonance that is around half the line impedance in front of the Helmholtz resonator 100), the vertical distance Lₙ, of the throat 122 of the acoustic horn 120 to the inner surface of the side wall 111 may be greater than two times a thickness of a thermoviscous boundary layer 140 at the inner surface of the 112 wall at resonance of the Helmholtz resonator 100. This would otherwise impede exploiting the Helmholtz resonator 100 in conjunction with similar Helmholtz resonators in, e.g., an acoustic metamaterial as the line impedance then naturally becomes smaller (due to the larger cross-section) and perfect absorption in the parallel circuit of several such Helmholtz resonators can no longer be achieved.

The wall thickness aw of the acoustic horn 120 may be smaller than the vertical distance Lₘ from the opening 115 in the body 110 to the throat 122 of the acoustic horn 120 to achieve all of the beneficial effects described herein.

The absorption factor α of the Helmholtz resonator 100 is given by:

$$α = 1 - {\vert r \vert}^{2} \qquad ( 13 )$$

As can be seen from mathematical expression (13), the absorption factor α depends on the reflection factor r of the Helmholtz resonator 100. The reflection factor r of the Helmholtz resonator 100 is given by:

$$r = \frac{{Z}_{H R} - {Z}_{0}}{{Z}_{H R} + {Z}_{0}} \qquad ( 14 )$$

It is evident from mathematical expression (13) that the reflection factor r becomes zero if the Helmholtz resonator 100's acoustic impedance matches the acoustic impedance Z₀ of the line. If no energy is reflected, all the energy is absorbed by the Helmholtz resonator 100, i.e., α=1.

Imperfect absorption poses a problem for acoustical absorber technology, the impedance of conventional Helmholtz resonators is often too small due to insufficient losses. This problem is even aggravated when several conventional Helmholtz resonators each tuned to a different frequency are arranged in parallel to yield absorption across a wider frequency range. In that case, the impedance of all conventional Helmholtz resonators is put in parallel and is even smaller in magnitude, thus again standing in the way of perfect absorption. This problem is overcome by the Helmholtz resonator 100 achieving a significantly higher acoustic impedance due to the acoustic horn 120.

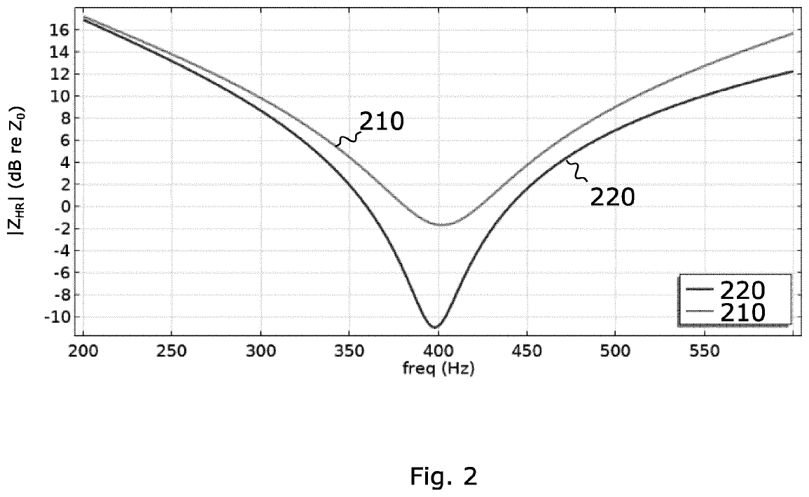

FIG. 2 illustrates a comparison of the acoustic impedances of a first Helmholtz resonator comprising an acoustic horn that serves as acoustic mass (curve 210) and a second Helmholtz resonator comprising a tubular duct that serves as acoustic mass (curve 220). The first Helmholtz resonator is a Helmholtz resonator as proposed herein. The second Helmholtz resonator serves as reference for the comparison. The ordinate of the diagram illustrated in FIG. 2 denotes the acoustic impedance of the respective Helmholtz resonator. The abscissa of the diagram denotes frequency.

In the example of FIG. 2, the tubular duct of the second Helmholtz resonator exhibits a radius r_{d}. The first Helmholtz resonator exhibits a cone shape similar to what is illustrated in FIG. 1. The radius of the throat of the acoustic horn is rₜ=0.282·r_{d}, whereas the radius of the mouth of the acoustic horn is rₘ=3.7·r_{d}. The overall length of the first second Helmholtz resonator's tubular duct is equal to the distance between throat and mouth of the first Helmholtz resonator's acoustic horn.

When comparing the curves 210 and 220, it is evident that, while the resonance frequency of the first Helmholtz resonator is only slightly higher (approx. 402 Hz vs. approx. 398 Hz), the magnitude of the acoustical impedance has grown significantly. That is, the Helmholtz resonator as proposed herein achieves substantially the same resonance frequency as a conventional Helmholtz resonator with embedded mass channel but has a significantly increased overall acoustic impedance at resonance with respect to the absolute value. This is particularly useful when it comes to impedance matching around the resonance of the Helmholtz resonator, as it offers one more degree of freedom compared to conventional designs.

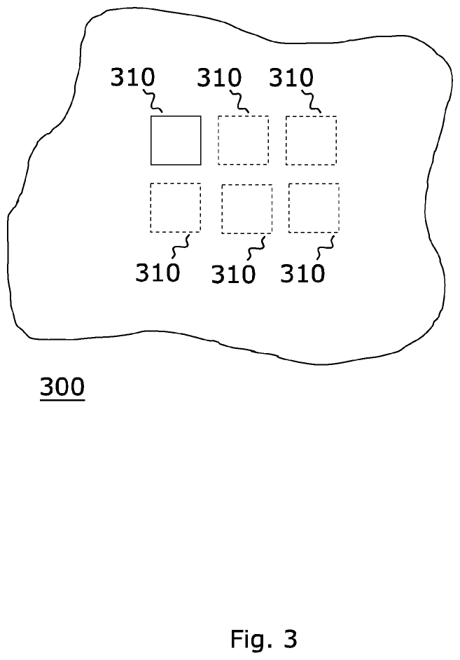

As stated above, Helmholtz resonators have many applications in acoustics. In the following, four exemplary applications for a Helmholtz resonator as proposed will be described with reference to FIGS. 3 to 6. However, it is to be noted that the present disclosure is not limited to the below exemplary applications. A Helmholtz resonator as proposed may be used for any acoustical device that requires a resonator or benefits from a resonator.

FIG. 3 illustrates an acoustic metamaterial 300. The acoustic metamaterial is a material designed to control, direct and/or manipulate sound (e.g., sound waves or phonons) in a propagation medium (e.g., a fluid such as a gas or a liquid). The acoustic metamaterial 300 comprises at least one Helmholtz resonator 310 as proposed herein. As indicated in FIG. 3, the acoustic metamaterial 300 may optionally comprise a plurality of Helmholtz resonators 310 as proposed herein.

As described above, the acoustic horn of the Helmholtz resonator 310 helps to form a resonator in combination with the attached acoustic compliance, but it also serves as a transformer to better match the impedance of the Helmholtz resonator 310 to match that of the equivalent acoustic transmission line in front of it. Accordingly, substantially ideal absorption may be achieved at the resonance frequency of the Helmholtz resonator 310. The Helmholtz resonator 310 may, hence, allow to provide an acoustic metamaterial with excellent absorption properties.

This advantage also benefits the parallel combination of several Helmholtz resonators 310, since their joint impedance is smaller than that of a Helmholtz resonator. In case the plurality of Helmholtz resonators 310 exhibit different resonance frequencies, the acoustic metamaterial 300 may provide good absorption across a wider frequency range.

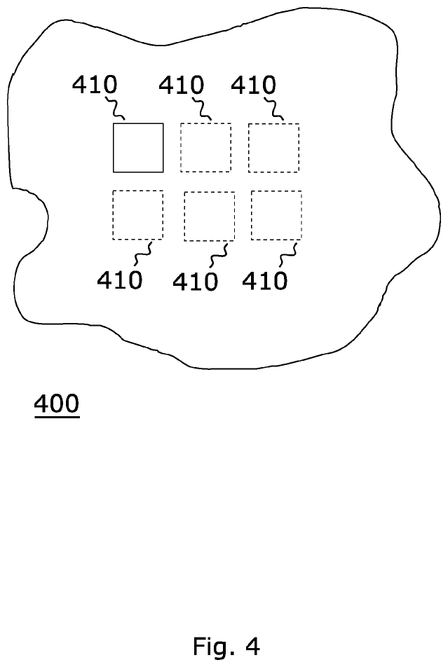

FIG. 4 illustrates an acoustic absorber 400. The acoustic absorber 400 takes in sound energy when sound waves are encountered. Part of the absorbed energy is transformed into heat and part is transmitted through the acoustic absorber 400. The acoustic absorber 400 comprises at least one Helmholtz resonator 410 as proposed herein. As indicated in FIG. 4, the acoustic absorber 400 may optionally comprise a plurality of Helmholtz resonators 410 as proposed herein.

As described above, the Helmholtz resonator 410 may provide substantially ideal absorption at the resonance frequency of the Helmholtz resonator 410. The Helmholtz resonator 410 may, hence, allow to provide an acoustic absorber with excellent absorption properties.

This advantage also benefits the parallel combination of several Helmholtz resonators 410, since their joint impedance is smaller than that of a Helmholtz resonator. In case the plurality of Helmholtz resonators 410 exhibit different resonance frequencies, the acoustic absorber 400 may provide good absorption across a wider frequency range.

For example, the proposed Helmholtz resonator may allow to provide a wideband absorber in the form of acoustic metamaterial.

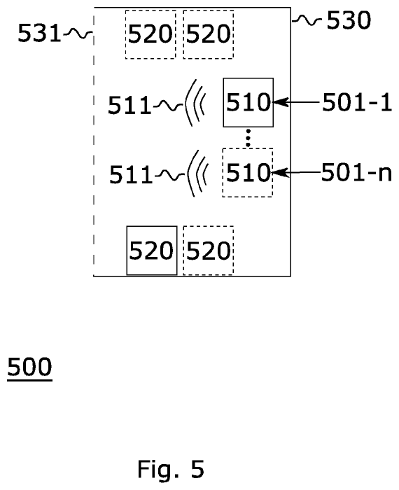

FIG. 5 illustrates a sound output device 500 such as a loudspeaker or a headphone (earphone). The sound output device 500 comprises one or more electroacoustic transducer 510 configured to convert a respective electrical audio signal 501-1, . . . , 501-n into sound 511. The one or more electroacoustic transducer 510 is an example for an active acoustic element. The number and positioning of the electroacoustic transducers 510 may be selected according to the desired properties of the sound output device 500. The one or more electroacoustic transducer 510 are arranged within a housing 530 of the sound output device 500. Recesses 531 are provided in the housing 530 such that the sound 511 can exit the sound output device 500 and propagate to a listening area.

The sound output device 500 further comprises one or more Helmholtz resonator 520 as proposed herein to control propagation of the sound 511 (within the housing 530 and, hence, also outside the housing). For example, the one or more Helmholtz resonator 520 may be arranged at predefined positions within the housing 530 to selectively absorb part of the sound 511 for controlling the propagation of the sound 511. For example, the one or more Helmholtz resonator 520 may be provided by means of an acoustic metamaterial or an acoustic absorber as described above.

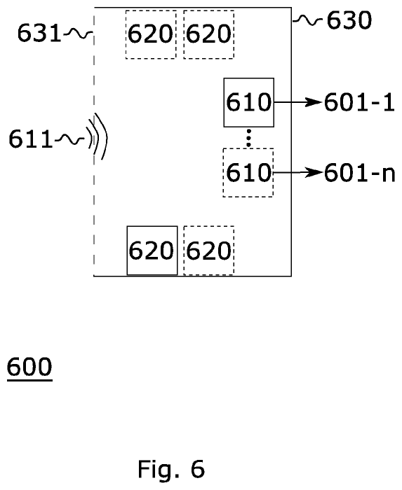

FIG. 6 illustrates a microphone 600. Sound 611 can enter a housing 630 of the microphone 600 through recesses 631 in the housing 630. One or more electroacoustic transducer 610 are arranged within the housing 630 and configured to convert the sound 611 into a respective electrical audio signal 601-1, . . . , 601-n. The number and positioning of the electroacoustic transducers 610 may be selected according to the desired properties of the microphone 600.

The microphone 600 further comprises one or more Helmholtz resonator 620 as proposed herein to control propagation of the sound 611 within the housing 630. For example, the one or more Helmholtz resonator 620 may be arranged at predefined positions within the housing 630 to selectively absorb part of the sound 611 for controlling the propagation of the sound 611. For example, the one or more Helmholtz resonator 620 may be provided by means of an acoustic metamaterial or an acoustic absorber as described above.

As described above, a Helmholtz resonator as proposed herein may be used for various applications. For example, a compact Helmholtz resonator as proposed herein may be used for applications with demanding requirements on available space, resonance frequency, quality factor and simplicity of manufacture.

The following examples pertain to further embodiments:

(1) A Helmholtz resonator, comprising:
a body enclosing a cavity, wherein the cavity serves as acoustic compliance of the Helmholtz resonator; and
an acoustic horn extending from an opening in the body into the cavity, wherein the acoustic horn serves as acoustic mass of the Helmholtz resonator.

(2) The Helmholtz resonator of (1), wherein the acoustic horn extends exclusively inside the cavity.

(3) The Helmholtz resonator of (1) or (2), wherein a cross section of the acoustic horn decreases with increasing distance from the opening in the body.

(4) The Helmholtz resonator of any one of (1) to (3), wherein the acoustic horn exhibits a conic shape.

(5) The Helmholtz resonator of any one of (1) to (3), wherein the acoustic horn exhibits a hyperbolic shape.

(6) The Helmholtz resonator of any one of (1) to (3), wherein the acoustic horn exhibits a parabolic shape.

(7) The Helmholtz resonator of any one of (1) to (6), wherein the mouth of the acoustic horn extends from the opening in the body, and wherein the acoustic horn is coupled to the body only by means of the mouth of the acoustic horn.

(8) The Helmholtz resonator of any one of (1) to (7), wherein a vertical distance of the throat of the acoustic horn to a first wall of the body is greater than two times a thickness of a thermoviscous boundary layer at the first wall at resonance of the Helmholtz resonator, the first wall being opposite to a second wall of the body in which the opening is formed.

(9) The Helmholtz resonator of any one of (1) to (8), wherein a wall thickness of the acoustic horn is smaller than a vertical distance from the opening in the body to the throat of the acoustic horn.

(10) The Helmholtz resonator of any one of (1) to (9), wherein the Helmholtz resonator comprises only passive acoustic elements.

(11) The Helmholtz resonator of any one of (1) to (10), wherein the body is formed of rigid material.

(12) The Helmholtz resonator of any one of (1) to (11), wherein the body exhibits a rectangular parallelepiped shape.

(13) The Helmholtz resonator of (12), wherein the body exhibits a cube shape.

(14) An acoustic metamaterial comprising one or more Helmholtz resonator according to any one of (1) to (13).

(15) The acoustic metamaterial of (14), wherein the acoustic metamaterial comprises a plurality of Helmholtz resonators according to any one of (1) to (13), and wherein the plurality of Helmholtz resonators exhibit different resonance frequencies.

(16) An acoustic absorber comprising one or more Helmholtz resonator according to any one of (1) to (13).

(17) The acoustic absorber of (16), wherein the acoustic absorber comprises a plurality of Helmholtz resonators according to any one of (1) to (13), and wherein the plurality of Helmholtz resonators exhibit different resonance frequencies.

(18) A sound output device, comprising:
one or more electroacoustic transducer configured to convert a respective electrical audio signal into sound; and
one or more Helmholtz resonator according to any one of (1) to (13) configured to control propagation of the sound.

(19) The sound output device of (18), wherein the sound output device is one of a loudspeaker and a headphone.

(20) A microphone, comprising:
one or more electroacoustic transducer configured to convert sound into a respective electrical audio signal; and
one or more Helmholtz resonator according to any one of (1) to (13) configured to control propagation of the sound within the microphone.

The aspects and features described in relation to a particular one of the previous examples may also be combined with one or more of the further examples to replace an identical or similar feature of that further example or to additionally introduce the features into the furthe example.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A Helmholtz resonator, comprising:
a body enclosing a cavity, wherein the cavity serves as acoustic compliance of the Helmholtz resonator; and
an acoustic horn extending from an opening in the body into the cavity, wherein the acoustic horn serves as acoustic mass of the Helmholtz resonator.

2. The Helmholtz resonator of claim 1, wherein the acoustic horn extends exclusively inside the cavity.

3. The Helmholtz resonator of claim 1, wherein a cross section of the acoustic horn decreases with increasing distance from the opening in the body.

4. The Helmholtz resonator of claim 1, wherein the acoustic horn exhibits a conic shape.

5. The Helmholtz resonator of claim 1, wherein the acoustic horn exhibits a hyperbolic shape.

6. The Helmholtz resonator of claim 1, wherein the acoustic horn exhibits a parabolic shape.

7. The Helmholtz resonator of claim 1, wherein the mouth of the acoustic horn extends from the opening in the body, and wherein the acoustic horn is coupled to the body only by means of the mouth of the acoustic horn.

8. The Helmholtz resonator of claim 1, wherein a vertical distance of the throat of the acoustic horn to a first wall of the body is greater than two times a thickness of a thermoviscous boundary layer at the first wall at resonance of the Helmholtz resonator, the first wall being opposite to a second wall of the body in which the opening is formed.

9. The Helmholtz resonator of claim 1, wherein a wall thickness of the acoustic horn is smaller than a vertical distance from the opening in the body to the throat of the acoustic horn.

10. The Helmholtz resonator of claim 1, wherein the Helmholtz resonator comprises only passive acoustic elements.

11. The Helmholtz resonator of claim 1, wherein the body is formed of rigid material.

12. The Helmholtz resonator of claim 1, wherein the body exhibits a rectangular parallelepiped shape.

13. The Helmholtz resonator of claim 12, wherein the body exhibits a cube shape.

14. An acoustic metamaterial comprising one or more Helmholtz resonator according to claim 1.

15. The acoustic metamaterial of claim 14, wherein the acoustic metamaterial comprises a plurality of Helmholtz resonators according to claim 1, and wherein the plurality of Helmholtz resonators exhibit different resonance frequencies.

16. An acoustic absorber comprising one or more Helmholtz resonator according to claim 1.

17. The acoustic absorber of claim 16, wherein the acoustic absorber comprises a plurality of Helmholtz resonators according to claim 1, and wherein the plurality of Helmholtz resonators exhibit different resonance frequencies.

18. A sound output device, comprising:
one or more electroacoustic transducer configured to convert a respective electrical audio signal into sound; and
one or more Helmholtz resonator according to claim 1 configured to control propagation of the sound.

19. The sound output device of claim 18, wherein the sound output device is one of a loudspeaker and a headphone.

20. A microphone, comprising:
one or more electroacoustic transducer configured to convert sound into a respective electrical audio signal; and
one or more Helmholtz resonator according to claim 1 configured to control propagation of the sound within the microphone.
